(19) United States
(12) Patent Application Publication
(10) Pub. No.: US 2021/0286994 A1
(43) Pub. Date: Sep. 16, 2021

(54) INFORMATION PROCESSING APPARATUS

(71) Applicant: FUJIFILM BUSINESS INNOVATION CORP., Tokyo (JP)

(72) Inventors: Hirohito SHIBATA, Kanagawa (JP); Satoshi MOHRI, Kanagawa (JP)

(73) Assignee: FUJIFILM BUSINESS INNOVATION CORP., Tokyo (JP)

(21) Appl. No.: 16/987,596

(22) Filed: Aug. 7, 2020

(30) Foreign Application Priority Data
Mar. 11, 2020 (JP) 2020-041689

(51) Int. Cl. G06K 9/00; G06F 3/0483

(52) U.S. Cl. CPC G06K 9/00463; G06K 9/00469; G06F 3/0483

(57) ABSTRACT

An information processing apparatus includes a processor configured to acquire first information indicating a currently read part of a paper book, acquire second information indicating a currently read part of an e-book containing a work identical to a work in the paper book, and cause the currently read part of the paper book to be displayed in the e-book. The currently read part is indicated by the acquired first information. The processor is also configured to cause a book image in which the currently read part of the e-book is represented in the paper book to be displayed. The currently read part is indicated by the acquired second information.

### CROSS-REFERENCE TO RELATED APPLICATIONS

This application is based on and claims priority under 35 USC 119 from Japanese Patent Application No. 2020-041689 filed Mar. 11, 2020.

### Background

### (i) Technical Field

The present disclosure relates to an information processing apparatus.

### (ii) Related Art

Japanese Unexamined Patent Application Publication No. 2015-041131 describes technology for providing a bookmark on pages in the e-book data. Specifically, images of a barcode as a book identification code and pages intended to be provided with a bookmark among pages of a book using paper as a medium are captured with a user device, image recognition is performed on the acquired image data, the book and a part for the bookmark in the book are identified, and a bookmark is provided in the part in the data of an e-book corresponding to the paper book.

### SUMMARY

The technology in Japanese Unexamined Patent Application Publication No. 2015-041131 enables a bookmark in the e-book to be synchronized with a bookmark in the paper book but does not enable the bookmark in paper book the to be synchronized with that in the e-book.

Aspects of non-limiting embodiments of the present disclosure relate to easy identification of a currently read part of one of a paper book and an e-book that contain the identical work as a currently read part of the other one of the paper book and the e-book.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to acquire first information indicating a currently read part of a paper book, acquire second information indicating a currently read part of an e-book containing a work identical to a work in the paper book, and cause the currently read part of the paper book to be displayed in the e-book. The currently read part is indicated by the acquired first information. The processor is also configured to cause a book image in which the currently read part of the e-book is represented in the paper book to be displayed. The currently read part is indicated by the acquired second information.

### BRIEF DESCRIPTION OF THE DRAWINGS

An exemplary embodiment of the present disclosure will be described in detail based on the following figures, wherein:

FIG. 1 is a diagram illustrating the hardware configuration of a reading assistive device according to the exemplary embodiment;

FIG. 2 is a diagram illustrating the functional configuration implemented by the reading assistive device;

FIG. 3 is a view illustrating an example menu screen;

FIG. 4 is a view illustrating an example of an acquired cover image;

FIG. 5 is a view illustrating an example of an acquired captured image;

FIG. 6 is a view illustrating an example of a displayed e-book;

FIGS. 7A and 7B are views each illustrating an example of the displayed operation image;

FIG. 8 is a view illustrating an example of a displayed paper book image;

FIG. 9 is a flowchart illustrating an example of operation steps in an e-book reading assistive process;

FIG. 10 is a flowchart illustrating an example of operation steps in a paper book reading assistive process;

FIG. 11 is a view illustrating an example side image; and

FIGS. 12A and 12B are views each illustrating an example paper book image in a modification.

### DETAILED DESCRIPTION

### 1. Exemplary Embodiment

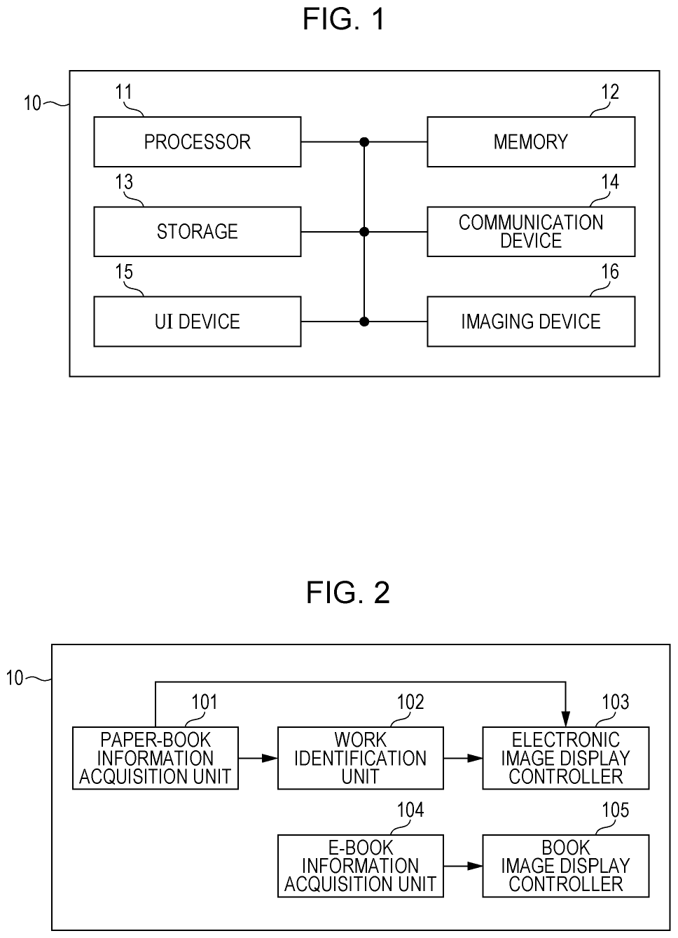

FIG. 1 illustrates the hardware configuration of a reading assistive device 10 according to the exemplary embodiment. The reading assistive device 10 is a device, such as a smartphone or a tablet terminal, that performs processing for assisting a user with their reading. The reading assistive device 10 is an example of an information processing apparatus of the present disclosure. The reading assistive device 10 assists reading both the paper book and the e-book.

The reading assistive device 10 particularly assists reading an e-book in which a work identical to a work in a paper book is contained. In this exemplary embodiment, the reading assistive device 10 also has a function of displaying an e-book, and the user uses the reading assistive device 10 as an e-book reader. The reading assistive device 10 is a computer including a processor 11, a memory 12, a storage 13, a communication device 14, a user interface (UI) device 15, and an imaging device 16.

The processor 11 includes an arithmetic unit such as a central processing unit (CPU), a register, peripheral circuits, and other components. The processor 11 is an example of a processor of the present disclosure. The memory 12 is a recording medium readable by the processor 11 and includes a random access memory (RAM), a read only memory (ROM), and other components. The storage 13 is a recording medium readable by the processor 11 and includes a hard disk drive, a flash memory, or the like.

The processor 11 controls the operation of the hardware by running a program stored in the ROM or the storage 13 with the RAM used as a work area. The processor 11 runs, for example, an application program (a reading assistive application) for assisting reading by the user and receives input of a character string. The reading assistive application assists reading not only the e-book but also a paper book, that is, a book using paper as a medium.

The communication device 14 includes an antenna, a communication circuit, and other components and performs communications via a communication network (not illustrated). Programs run by the processor 11 may be acquired from an external apparatus communicating via the communication device 14. The UI device 15 is an interface provided for the user using the reading assistive device 10. The interface is a device that receives information input by the user and outputs information from the reading assistive device 10.

The UI device 15 has a touch screen including, for example, a display used for displaying and a touch panel disposed on the surface of the display. The UI device 15 displays an image and receives a user operation. The imaging device 16 includes an optical system such as a lens and an image sensor. The imaging device 16 is a digital camera used for capturing an image in the angle of view. The imaging device 16 provides the processor 11 with image data representing the captured image.

The reading assistive device 10 implements the following functions in such a manner that the processor 11 controls component units by running the program (reading assistive application).

FIG. 2 illustrates the functional configuration implemented by the reading assistive device 10. The reading assistive device 10 includes a paper-book information acquisition unit 101, a work identification unit 102, an electronic image display controller 103, an e-book information acquisition unit 104, and a book image display controller 105.

The paper-book information acquisition unit 101 acquires information regarding a paper book (hereinafter, referred to as paper book information). The reading assistive device 10 displays the menu screen of the reading assistive application as a screen for performing operations for the paper book information and the like.

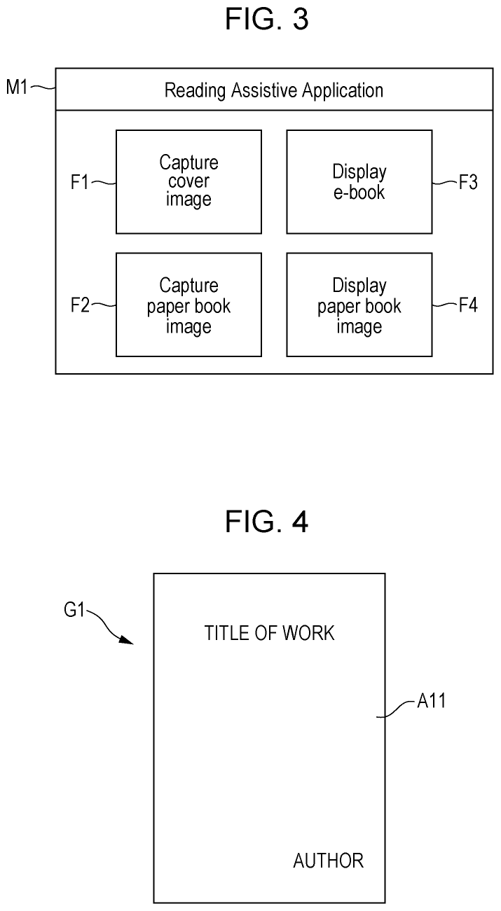

FIG. 3 illustrates an example menu screen. In the example in FIG. 3, the reading assistive device 10 displays a menu screen M1 including an operation image F1 for capturing an image of the cover of a paper book, an operation image F2 for capturing an image of a page of the paper book, an operation image F3 for displaying an e-book, and an operation image F4 for displaying a paper book image.

When stopping reading the paper book, the user causes the menu screen M1 to be displayed and performs operations for selecting the operation images F1 and F2. The paper-book information acquisition unit 101 then starts the imaging device 16, and the imaging device 16 becomes ready for capturing an image. The operation image F1 is herein selected first. In this case, the user operates the reading assistive device 10 to capture an image of the cover of the paper book. The paper-book information acquisition unit 101 acquires, as paper book information, the cover image representing the captured image of the cover of the paper book.

FIG. 4 illustrates an example of the acquired cover image. In the example in FIG. 4, a cover image G1 of a paper book A11 is illustrated. The paper-book information acquisition unit 101 supplies the work identification unit 102 with the acquired cover image. The work identification unit 102 acquires the supplied captured image, that is, the cover image captured as the image of the cover of the paper book. The work identification unit 102 then identifies the work contained in the paper book corresponding to the captured cover image, on the basis of the acquired cover image.

The work identification unit 102 stores a table of works in which, for example, the cover images of various paper books are respectively associated with names of works. The work identification unit 102 identifies the work in the paper book by identifying the name of the work associated in the table of works with a cover image having similarity to the supplied cover image, the similarity being higher than or equal to a threshold. Upon identifying the work, the work identification unit 102 supplies the electronic image display controller 103 with the name of the identified work.

The user subsequently selects the operation image F2. In this case, the user captures an image of the paper book by pointing the last part of sentences already read by themselves in the opened page of the paper book. The last part is pointed as a currently read part with a tool such as a finger or a pen. The paper-book information acquisition unit 101 acquires the captured image representing the image of the paper book as paper book information.

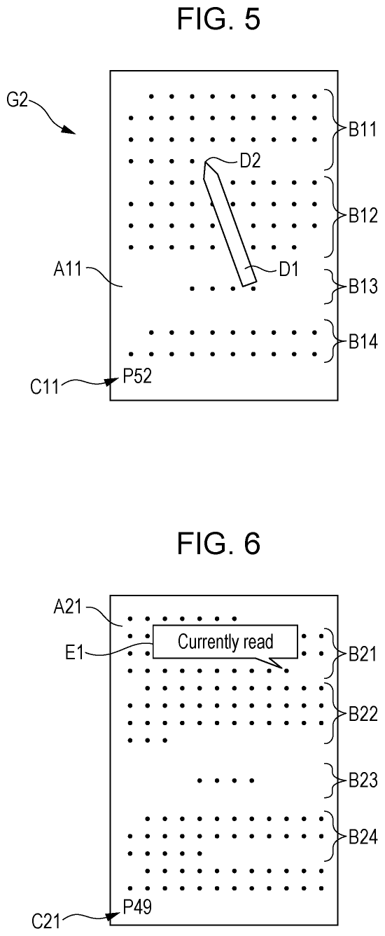

FIG. 5 illustrates an example of the acquired captured image. In the example in FIG. 5, a captured image G2 captured for page 52 of the paper book A11 is illustrated. Page 52 includes paragraphs B11, B12, B13, and B14, and a number image C11 representing P52 indicating the 52nd page. The user captures an image of the paper book A11 with the last part of the paragraph B11 being pointed with a pen point D2 of a pen D1. A hand of the user holding the pen D1 is omitted in FIG. 5 for better visibility.

When the user stops reading the paper book, the paper-book information acquisition unit 101 acquires, as the paper book information, the captured image as illustrated in FIG. 5, that is, information indicating the currently read part of the paper book. The paper book information in this case is an example of first information of the present disclosure. The paper-book information acquisition unit 101 supplies the electronic image display controller 103 with the acquired captured image. The electronic image display controller 103 performs display control in which the images of pages of the e-book containing the work identified by the work identification unit 102 are displayed on the display of the reading assistive device 10 (display of the UI device 15).

When an operation is performed on the operation image F3 illustrated in FIG. 3, the reading assistive device 10 starts the display control described above. The reading assistive device 10 stores, for example, book data indicating an e-book in association with the name of the work in the e-book. The electronic image display controller 103 reads out the book data stored in association with the name of the work supplied from the work identification unit 102 and causes the e-book indicated by the read out book data to be displayed.

At this time, the electronic image display controller 103 causes an image representing the currently read part of the paper book indicated by the paper book information acquired by the paper-book information acquisition unit 101 to be displayed in the e-book. Specifically, the electronic image display controller 103 recognizes the currently read page on the basis of the captured image and causes a section including the part pointed in the recognized page to be displayed in the e-book containing the work identified by the work identification unit 102.

The electronic image display controller 103 stores character position data in advance. The character position data indicates, for example, the position of each of characters in the sentences in each page of the paper book A11. If the captured image G2 in FIG. 5 is acquired, the electronic image display controller 103 recognizes the characters in the number image C11, recognizes the number image C11 as page 52, and reads out character position data regarding page 52. The electronic image display controller 103 then recognizes the shape of the pen D1 from the captured image G2 and thereby recognizes the position of the pen point D2. If the currently read part is pointed with a fingertip instead of the pen, the electronic image display controller 103 may recognize the position of the fingertip by recognizing the shape of the finger.

The electronic image display controller 103 identifies a character pointed at the recognized position of the pen point D2 as a character indicating the currently read part in the character position data read out. In the example in FIG. 5, the electronic image display controller 103 identifies the character at the end of the paragraph B11 as the character indicating the currently read part. The electronic image display controller 103 causes, to be displayed, a page including the identified character of sentences included in the e-book and a notification image for notifying the user that the identified character corresponds to the currently read part.

FIG. 6 illustrates an example of a displayed e-book. In the example in FIG. 6, the electronic image display controller 103 causes paragraphs B21, B22, B23, and B24 on page 49 of an e-book A21 to be displayed. These paragraphs correspond to the paragraphs B11, B12, B13, and B14 illustrated in FIG. 5. The electronic image display controller 103 also causes a pointing image E1 pointing at the character identified as the currently read part to be displayed.

The pointing image E1 is composed of a rectangular image including the character string “currently read” and a part pointing at the character identified as the currently read part. In the example in FIG. 6, the page number (page 52) of the paper book differs from the page number (page 49) of the e-book. This is because the size of characters is changeable in the e-book and thus the number of characters displayed on one page varies.

Changing the size of the characters in the e-book leads to a large or small difference of the page number from the page number in the paper book and accordingly leads to a positional change of the character identified as the currently read part. In this case, the electronic image display controller 103 changes the display position of the pointing image E1 to remain pointing at the position of the identified character. Displaying the pointing image E1 in this manner causes a currently read part of the paper book to be displayed more minutely than in a case where a pointing image is not displayed.

The e-book information acquisition unit 104 acquires information regarding an e-book (hereinafter, referred to as e-book information). For example, when the user stops reading the e-book A21 illustrated in FIG. 6, the e-book information acquisition unit 104 acquires information indicating the currently read part as the e-book information. Specifically, the e-book information acquisition unit 104 acquires the e-book information indicating the currently read part of the e-book A21 containing a work identical to the work in the paper book A11 illustrated in FIG. 5. The e-book information in this case is an example of second information of the present disclosure.

When the reading of the e-book is stopped, the electronic image display controller 103 causes an operation image for confirming the stopping to be displayed.

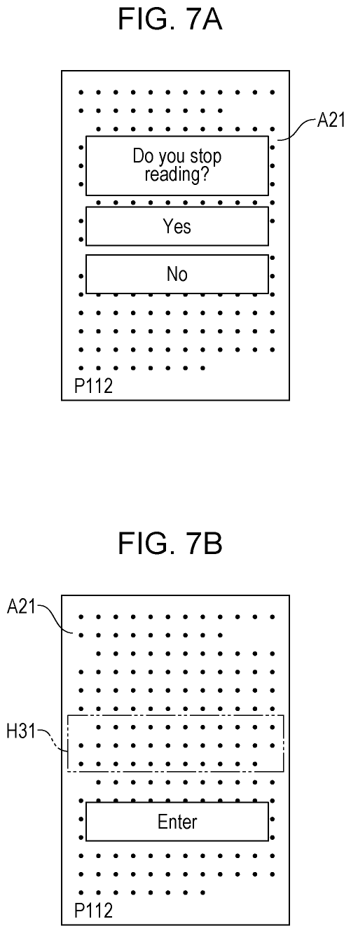

FIGS. 7A and 7B each illustrate an example of the displayed operation image. After a predetermined operation such as a double tap is performed while the e-book A21 is being displayed, the electronic image display controller 103 causes, for example, the character string “Do you stop reading?”, a Yes button, and a No button to be displayed as illustrated in FIG. 7A.

When the user performs an operation for selecting the Yes button, the electronic image display controller 103 causes a stop image H31 and an Enter button to be displayed as illustrated in FIG. 7B. The stop image H31 is an image indicating where the reading is stopped and is an image of a frame surrounding the paragraph where the reading is stopped in the example in FIG. 7B. For example, when the user swipes the stop image H31 upwards or downwards, the electronic image display controller 103 thus changes the paragraph representing the reading stop part in the display.

After the operation is performed on the confirmation button, the e-book information acquisition unit 104 acquires, as information indicating the currently read part, paragraph information indicating the stop image H31 displayed at that time. The paragraph information is information indicating the order of, for example, the paragraph indicating the currently read part out of all paragraphs for the sentences of the e-book. Note that a stop image is not limited to the information regarding a paragraph indicating the currently read part and may be, for example, information regarding a character indicating the currently read part. In this case, for example, an image surrounding the character may be used as the stop image, and the number of characters from the top of the sentence to the character indicating the currently read part may be used as the information indicating the currently read part.

The e-book information acquisition unit 104 supplies the book image display controller 105 with the information (in this exemplary embodiment, the paragraph information indicating the acquired currently read part). If the user stops reading the e-book and thereafter uses the paper book to continue the reading, the user performs an operation on the operation image F4 illustrated in FIG. 3 and provided for displaying the paper book image. The paper book image is an image in which the currently read part of the e-book is represented in the paper book. The paper book image is an example of a book image of the present disclosure.

After the operation is performed on the operation image F4, the book image display controller 105 causes the image in which the currently read part of the e-book is represented in the paper book to be displayed as the paper book image on the display. The currently read part is indicated by the e-book information acquired by the e-book information acquisition unit 104.

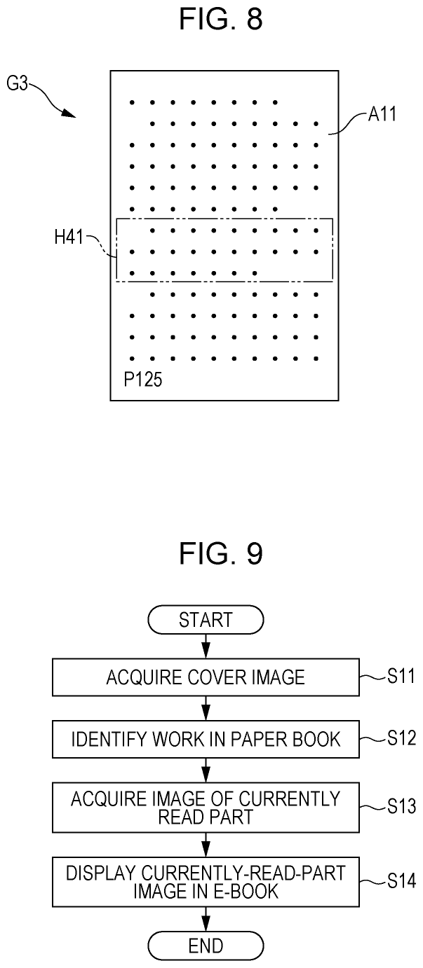

FIG. 8 illustrates an example of the displayed paper book image. In the example in FIG. 8, the book image display controller 105 causes a paper book image G3 representing the paper book A11 to be displayed.

The paper book image G3 reproduces the layout of a page of the paper book A11. The paper book image G3 also represents a paragraph image H41 surrounding a paragraph corresponding to the paragraph having the currently read part of the e-book. As described above, the book image display controller 105 causes, to be displayed as the paper book image G3, an image in which among the pages of the paper book, the layout of the page including the currently read part indicated by the acquired e-book information is represented and the image (paragraph image H41) in which the currently read part is represented in the layout.

With the configuration described above, the reading assistive device 10 executes a reading assistive process for assisting the user with their reading. The reading assistive process includes an e-book reading assistive process in which a currently read part is represented in the e-book and a paper book reading assistive process in which a currently read part is represented in the paper book.

FIG. 9 illustrates an example of operation steps in the e-book reading assistive process. First, the reading assistive device 10 (paper-book information acquisition unit 101) acquires a cover image representing the cover of a paper book (step S11).

On the basis of the acquired cover image, the reading assistive device 10 (work identification unit 102) identifies a work contained in the paper book from which a cover image is captured (step S12). The reading assistive device 10 (paper-book information acquisition unit 101) acquires information indicating the currently read part of the paper book (step S13). The reading assistive device 10 (electronic image display controller 103) causes an image (currently-read-part image) indicating the currently read part of the paper book indicated by the acquired paper book information to be displayed in the e-book (step S14).

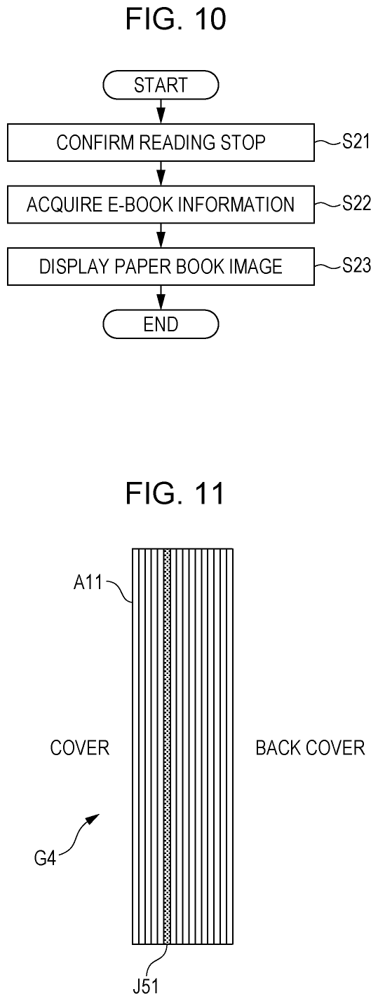

FIG. 10 illustrates an example of operation steps in the paper book reading assistive process. First, the reading assistive device 10 (electronic image display controller 103) performs a confirmation step for displaying an operation image for confirming the stopping of e-book reading (step S21). After an operation is performed on this operation image, the reading assistive device 10 (e-book information acquisition unit 104) acquires e-book information indicating the currently read part of the e-book A21 containing the work identical to the work in the paper book A11 (step S22). The reading assistive device 10 (book image display controller 105) causes, to be displayed as the paper book image, an image in which the currently read part of the e-book indicated by the e-book information acquired in step S22 is represented in the paper book (step S23).

In this exemplary embodiment, the currently read part of the paper book or the e-book is represented by a corresponding one of the currently-read-part image and the paper book image as described above. The currently read part of one of the paper book and the e-book that contain the identical work is thereby identified as the currently read part of the other one of the paper book and the e-book more easily than in a case where the currently read part is not displayed. In addition, in this exemplary embodiment, the use of the captured image having the pointed currently read part of the paper book leads to the identification of the currently read part, eliminating the need for typing, for example, a character indicating the currently read part of the paper book.

In addition, in this exemplary embodiment, the paper book image representing the layout and the currently read part is displayed as illustrated in FIG. 8, and thus time and effort to find the currently read part in the displayed page are saved as compared with a case where the paper book image is not displayed. In addition, in this exemplary embodiment, the e-book having the work identified from the cover image is displayed. This leads to the displaying of the e-book having the work identical to the work in the paper book, eliminating the need for typing, for example, characters indicating the title of the work.

### 2. Modifications

The exemplary embodiment described above is merely an example for implementing the present disclosure and may be modified as below. The exemplary embodiment and the modifications may be combined and implemented as necessary.

### 2-1. Page Recognition Method

The electronic image display controller 103 recognizes the currently read page by recognizing the number image representing the page number in the exemplary embodiment; however, the method for recognizing a currently read page is not limited thereto. The electronic image display controller 103 may store, for example, the layout of each page of the paper book and then may recognize a page in the layout matching the layout in the acquired captured image of the paper book. The page number of a page even without a printed page number is thereby recognized.

### 2-2. Side Image of Paper Book

The book image display controller 105 may cause a book image different from that in the exemplary embodiment to be displayed. In this modification, the book image display controller 105 causes the following images to be displayed as the paper book image: an image of a side view of a paper book (an image representing a specific side of the paper book and hereinafter referred to as a side image); and an image (hereinafter, referred to as a current-reading position image) representing the position of the page including the currently read part represented in the side image.

FIG. 11 illustrates an example side image. In the example in FIG. 11, the book image display controller 105 causes, to be displayed, a side image G4 of the paper book A11 and a current-reading position image J51 representing the position of the page including the currently read part. In the current-reading position image J51, the current reading position is closer to the cover in a direction of the thickness of the paper book A11 than to the back cover and represented by using a thick line in the example in FIG. 11. Displaying the side image G4 and the current-reading position image J51 causes the user to open the paper book at the page including the currently read part more quickly than in a case where the image of the side view of the paper book is not displayed.

### 2-3. Automatically Displaying Paper Book Image

In the exemplary embodiment, the book image display controller 105 causes the paper book image to be displayed when an operation is performed on the operation image F4 illustrated in FIG. 3; however, the method for displaying a paper book image is not limited thereto. In this modification, the book image display controller 105 causes the paper book image illustrated in, for example, FIG. 8 or 11 to be displayed if a period of time in which the e-book is not used is longer than or equal to a threshold.

As long as a period of time leads to a determination that the e-book is not to be used not only temporarily but also for some time (for example, approximately five or ten minutes), the period of time may be set as the threshold. If the user stops reading an e-book and starts reading a paper book after a while, the paper book image is displayed without performing an operation on the operation image because the threshold is set as described above. The paper book reading subsequent to the e-book reading is started more quickly than in a case where the paper book image is displayed only in response to the user operation.

### 2-4. Paper Book Image

In the exemplary embodiment, the book image display controller 105 causes the image (paragraph image H41) representing the currently read part to be displayed as the paper book image G3 in the layout of the page including the currently read part as illustrated in FIG. 8; however, the paper book image is not limited thereto. In this modification, the book image display controller 105 causes, to be displayed as the paper book image, an image representing the page of the paper book including the currently read part indicated by the e-book information acquired by the e-book information acquisition unit 104.

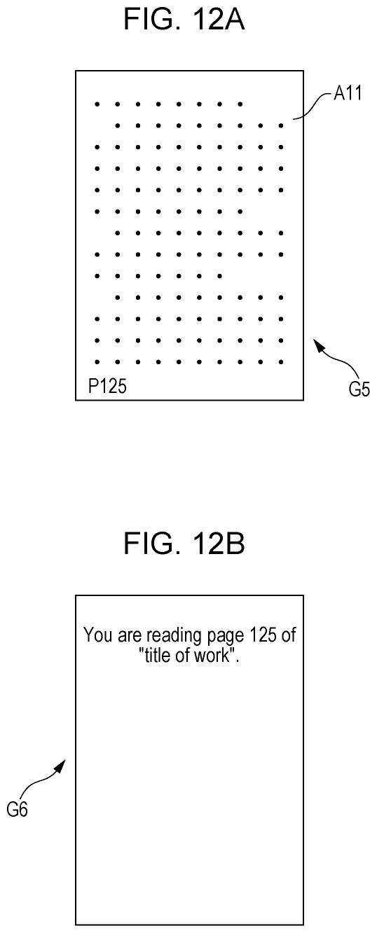

FIGS. 12A and 12B each illustrate an example paper book image in this modification. In the example in FIG. 12A, the book image display controller 105 causes only a paper book image G5 representing page 125 of the paper book A11 to be displayed. In the example in FIG. 12B, the book image display controller 105 causes, to be displayed, only a paper book image G6 representing the character string describing the title of the work in the paper book A11 and the reading on page 125.

To display the currently read part in the page as in the exemplary embodiment, the layout of the page, in other words, information indicating the respective positions of characters needs to be held. However, displaying only the page as in this modification leads to a smaller amount of data regarding the paper book than in the case where the specific position of the currently read part in the page is displayed as in the exemplary embodiment.

### 2-5. Functional Configuration

The method for implementing the functions illustrated in FIG. 2 is not limited to the methods described in the examples above. For example, the functions illustrated in FIG. 2 may all be implemented by an apparatus accessed via a communication network in a cloud system or the like, and the reading assistive device 10 operated directly by the user may be used only as a user interface including the display. In this case, the apparatus accessed via the communication network is an example of the information processing apparatus of the present disclosure.

The functions implemented by the reading assistive device 10 may be implemented by two or more apparatuses (such as apparatuses respectively for display and operations or apparatuses respectively held by the user and accessed via a communication network in cloud computing or the like). As described above, the information processing apparatus of the present disclosure may have all the components in one housing or may have the components in two or more separate housings. In the case of two or more separate housings, the components may be referred to as an information processing system.

Moreover, for example, in the examples above, the electronic image display controller 103 recognizes the currently read page from the captured image; however, the function of the recognition may be separately provided. In addition, for example, operations of the paper-book information acquisition unit 101 and the work identification unit 102 may be performed by one function. In sum, as long as the functions illustrated in FIG. 2 and the like are implemented as a whole, the configuration of the apparatuses implementing the functions and the scopes of the operations performed by the respective functions may be set freely.

### 2-6. Processor

In the embodiment above, the term “processor” refers to hardware in a broad sense. Examples of the processor include general processors (e.g., CPU: Central Processing Unit), and dedicated processors (e.g., GPU: Graphics Processing Unit, ASIC: Application Specific Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

### 2-7. Category of Disclosure

The present disclosure is regarded as not only the above-described information processing apparatus (including the case where the information processing apparatus is referred to as the information processing system) but also an information processing method for implementing the processing performed by the information processing apparatus and a program causing a computer controlling the devices to function. The program may be provided by using a recording medium storing the program, such as an optical disk, or in such a manner as to be downloaded by the computer via a communication network such as the Internet and then be made usable by being installed thereon.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

1. An information processing apparatus comprising:
a display for displaying an e-book containing a work identical to a work in a paper book;
an image capturing device; and
a processor configured to:
acquire first information indicating a currently read part of the paper book from the image capturing device of the information processing apparatus,
acquire second information indicating a currently read part of the e-book based on a user input to the display of the information processing apparatus,
display, on the display, the currently read part of the paper book as applied to the e-book, the currently read part being indicated by the acquired first information, and
display, on the display, a book image in which the currently read part of the e-book is represented in the paper book, the currently read part being indicated by the acquired second information.

2. The information processing apparatus according to claim 1,
wherein the processor
acquires, as the first information, a captured image in which the currently read part of the paper book is pointed, from the image capturing device,
recognizes a currently read page from the captured image, and
causes a section including the currently read part pointed in the recognized currently read page to be displayed in the e-book on the display.

3. The information processing apparatus according to claim 1,
wherein the processor
causes, to be displayed as the book image on the display, an image in which among pages of the paper book, a layout of a page including the currently read part indicated by the second information is represented and an image in which the currently read part is represented in the layout.

4. The information processing apparatus according to claim 3,
wherein the processor
causes, to be displayed as the book image on the display, an image of a side view of the paper book and an image in which a position of the page including the currently read part indicated by the second information is represented in the image of the side view.

5. The information processing apparatus according to claim 3,
wherein the processor
causes the book image to be displayed when a period of time in which the e-book is not used is longer than or equal to a threshold.

6. The information processing apparatus according to claim 4,
wherein the processor
causes the book image to be displayed when a period of time in which the e-book is not used is longer than or equal to a threshold.

7. The information processing apparatus according to claim 1,
wherein the processor
acquires, from the image capturing device, a cover image captured as an image of a cover of the paper book,
identifies the work contained in the paper book on a basis of the acquired cover image, and
displays, on the display, the currently read part of the paper book indicated by the acquired first information as applied to the e-book containing the identified work.

8. The information processing apparatus according to claim 2,
wherein the processor
acquires, from the image capturing device, a cover image captured as an image of a cover of the paper book,
identifies the work contained in the paper book on a basis of the acquired cover image, and
displays, on the display, the currently read part of the paper book indicated by the acquired first information as applied to the e-book containing the identified work.

9. The information processing apparatus according to claim 3,
wherein the processor
acquires, from the image capturing device, a cover image captured as an image of a cover of the paper book,
identifies the work contained in the paper book on a basis of the acquired cover image, and
displays, on the display, the currently read part of the paper book indicated by the acquired first information as applied to the e-book containing the identified work.

10. The information processing apparatus according to claim 4,
wherein the processor
acquires, from the image capturing device, a cover image captured as an image of a cover of the paper book,
identifies the work contained in the paper book on a basis of the acquired cover image, and
displays, on the display, the currently read part of the paper book indicated by the acquired first information as applied to the e-book containing the identified work.

11. The information processing apparatus according to claim 5,
wherein the processor
acquires, from the image capturing device, a cover image captured as an image of a cover of the paper book,
identifies the work contained in the paper book on a basis of the acquired cover image, and
displays, on the display, the currently read part of the paper book indicated by the acquired first information as applied to the e-book containing the identified work.

12. The information processing apparatus according to claim 6,
wherein the processor
acquires, from the image capturing device, a cover image captured as an image of a cover of the paper book,
identifies the work contained in the paper book on a basis of the acquired cover image, and
displays, on the display, the currently read part of the paper book indicated by the acquired first information as applied to the e-book containing the identified work.

13. The information processing apparatus according to claim 1,
wherein the processor
causes an image representing a page of the paper book to be displayed as the book image, the page including the currently read part indicated by the second information.

14. An information processing apparatus comprising:
displaying means for displaying an e-book containing a work identical to a work in a paper book;
image capturing means; and
processing means for
acquiring first information indicating a currently read part of the paper book from the image capturing device of the information processing apparatus,
acquiring second information indicating a currently read part of the e-book based on a user input to the display of the information processing apparatus,
displaying, on the displaying means, the currently read part of the paper book as applied to the e-book, the currently read part being indicated by the acquired first information, and
displaying, on the displaying means, a book image in which the currently read part of the e-book is represented in the paper book, the currently read part being indicated by the acquired second information.

15. The information processing apparatus according to claim 1, wherein the book image is displayed on the display to indicate the currently read part as applied to the paper book, without requiring a user to open or refer to the paper book.
